(19) United States
(12) Patent Application Publication
(10) Pub. No.: US 2016/0216037 A1
(43) Pub. Date: Jul. 28, 2016

(54) CHARGE AIR COOLER AND ASSOCIATED CHARGE AIR CIRCUIT

(71) Applicant: VALEO SYSTEMES THERMIQUES, Le Mesnil Saint Denis (FR)

(72) Inventors: Kamel Azzouz, Paris (FR); Georges De Pelsemaeker, Poigny-la-foret (FR)

(73) Assignee: Valeo Systemes Thermiques, Le Mesnil Saint Denis (FR)

(21) Appl. No.: 14/892,874

(22) PCT Filed: May 15, 2014
(86) PCT No.: PCT/EP2014/060030

§ 371 Date: Mar. 21, 2016

(30) Foreign Application Priority Data
May 22, 2013 (FR) 1354565

(51) Int. Cl. F28D 9/00; F28F 19/01; F02B 29/04; F28D 20/02

(52) U.S. Cl. CPC F28D 9/0093; F28D 20/023; F28F 19/01; F28D 9/0062; F02B 29/0475

(57) ABSTRACT

The present invention relates to a charge air cooler (7) intended to be placed upstream from the combustion cylinders (5), said charge air coming from at least one turbocharger (3) and intended to be supplied to the combustion cylinders (5) of an internal combustion engine, said charge air cooler (7) comprising one inlet container (70) for charge air, one outlet container for charge air and heat-exchange surfaces (72) between the charge air and a second heat-transfer fluid, at least the inlet container (70) and/or the outlet container for charge air comprising a phase change material (15).

The present invention relates to a thermal management system of a charge air circuit, in particular for a motor vehicle. More particularly, the invention relates to the cooling of the air from a turbocharger prior to its intake into the combustion cylinders of an internal combustion engine.

In the automotive field of turbocharged engines, it is known to cool the intake air, from at least one turbocharger, using at least one charge air cooler (RAS) placed upstream from the combustion cylinders. The RAS thus allows a reduction in the temperature of charge air, which is at a high temperature at the outlet of the turbocharger. Indeed, in a conventional charge circuit, the charge air undergoes compression at the turbocharger, thereby increasing its temperature and reducing its density. The drop in the temperature of intake air allows a reduction of the risks of auto-ignition and makes it possible to improve the density of the charge air, which enhances the combustion yield.

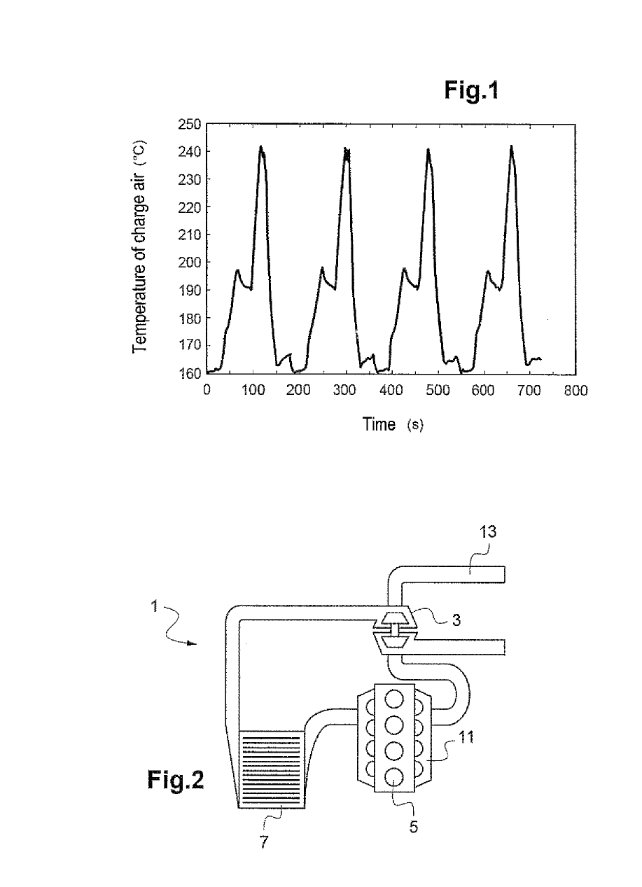

RASs are generally heat exchangers of air/air or, alternatively, air/liquid types, which undergo significant stresses, particularly from the thermal standpoint owing to the cyclic use of the turbocharger as a function of engine operation. Indeed, each time the turbocharger is used, charge air increases in pressure and in temperature. Increases in temperature of the charge air, linked to the use of the turbocharger, are illustrated in FIG. 1. Said FIG. 1 shows a temperature curve for the charge air at the outlet of the turbocharger as a function of time. It is thus possible to observe temperature peaks for the charge air, which may rise to as high as 240° C. when the turbocharger is used.

These significant temperature increases thus require the use of materials that can resist these high temperatures, the implementation of significant thicknesses of material for the purposes of the mechanical behavior of the elements and, likewise, the use of RASs of large size with a view to managing these high temperatures.

It is known to place two RASs of smaller size in series with a view to restricting the overall space requirement and to place them in the available spaces in the engine compartment. However, this solution is unsatisfactory because the reduction in the overall space requirement is limited and the increased number of RASs may give rise to increased manufacturing costs.

It is also known to place a phase change material within the conduit between the turbocharger and the RAS. However, an incorporation of this type requires modifications to the conduit in question so that it can receive the phase change material, and thus this may likewise give rise to increased manufacturing costs.

One of the objects of the invention is thus to at least in part remedy the drawbacks of the prior art and to propose an optimized charge air cooler and charge air circuit.

The present invention thus relates to a charge air cooler intended to be placed upstream from the combustion cylinders, said charge air coming from at least one turbocharger and intended to be supplied to the combustion cylinders of an internal combustion engine, said charge air cooler comprising one inlet container for charge air, one outlet container for charge air and heat exchange surfaces between the charge air and a second heat-transfer fluid, at least the inlet container and/or the outlet container for charge air comprising a phase change material.

The phase change material allows absorption of thermal energy coming from the charge air. This thermal energy absorbed by the phase change material is no longer to be dissipated by the charge air cooler when there are temperature peaks and thus said charge air cooler may be of smaller size but be equally as efficient.

According to one aspect of the invention, the phase change material is incorporated within the wall of the inlet container and/or the outlet container for charge air.

According to another aspect of the invention, the phase change material is in the form of capsules of phase change material placed in the inlet container and/or the outlet container for charge air.

The incorporation of the phase change material within the at least one inlet container and/or the at least one outlet container for the first heat-transfer fluid makes it possible to avoid an increase in the size of the charge air cooler.

According to another aspect of the invention, the inlet container and/or the outlet container for charge air comprising the capsules of phase change material comprises means for retaining said capsules of phase change material within said inlet container and/or said outlet container for charge air.

According to another aspect of the invention, the retaining means are placed at the inlets and/or outlets of the exchange surfaces and at the inlet of the inlet container for charge air and/or at the outlet of the outlet container for charge air.

According to another aspect of the invention, the means for retaining said capsules of phase change material within the inlet container and/or the outlet container for charge air are grids.

According to another aspect of the invention, the means for retaining said capsules of phase change material within the inlet container and/or the outlet container for charge air are filters.

According to another aspect of the invention, the phase change material has a phase change temperature of between 180° C. and 200° C.

According to another aspect of the invention, the phase change material has a latent heat greater than or equal to 280 kJ/m³.

The present invention also relates to a charge air circuit comprising a charge air cooler as described above.

Other features and advantages of the invention will become more clearly apparent upon reading the following description, given by way of non-limiting, illustrative example, and the appended drawings, in which:

FIG. 1 shows a temperature curve for the charge air as a function of time, at the outlet of the turbocharger,

FIG. 2 shows a schematic representation of a charge air circuit,

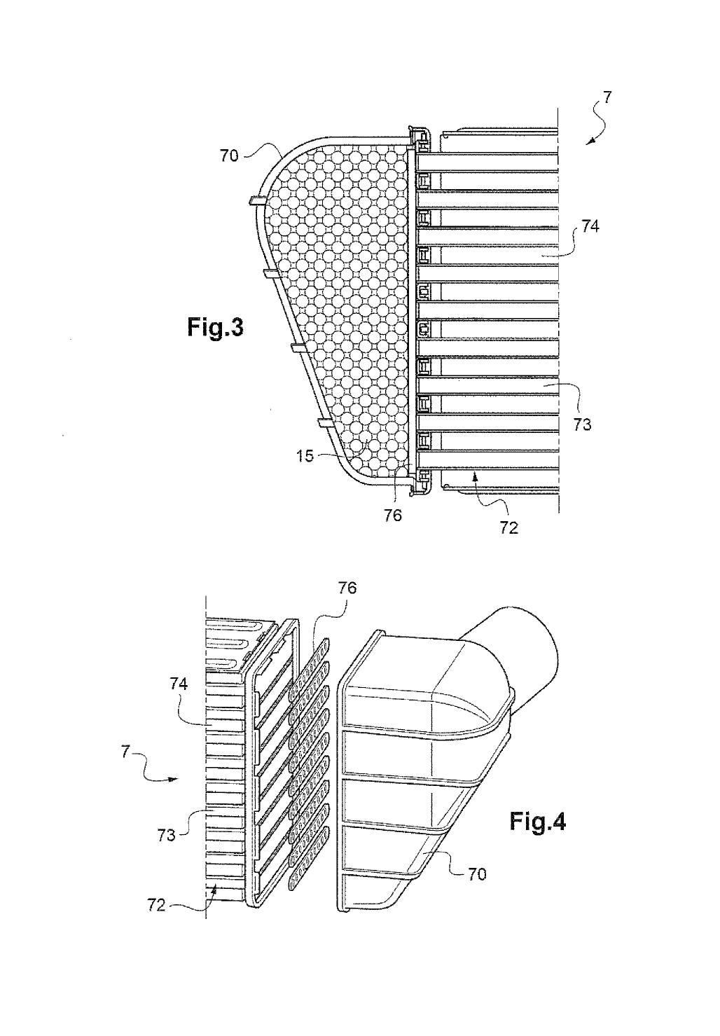

FIG. 3 shows a schematic representation, in section, of a charge air cooler,

FIG. 4 shows a schematic representation, in expanded perspective, of a charge air cooler,

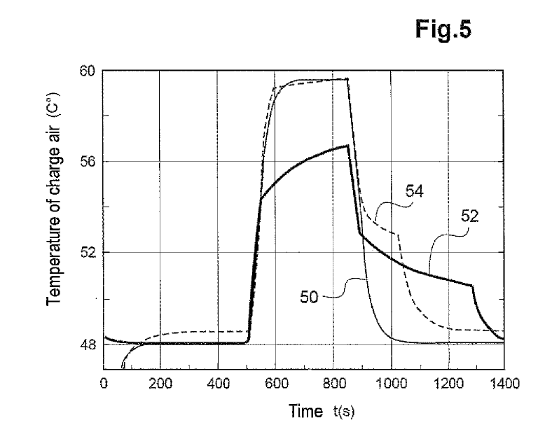

FIG. 5 shows a curve illustrating the evolution of the charge air temperature at the outlet of various types of charge air coolers.

In the various figures, identical elements bear the same reference numerals.

FIG. 2 shows a schematic representation of a charge air circuit 1. Said charge air circuit 1 comprises a turbocharger 3 that, through the action of the exhaust gases collected at the outlet of the exhaust manifold 11, compresses the air intended for the combustion cylinders 5, collected by the air intake 13. The charge air thus created then passes into a charge air cooler (RAS) 7 placed between the turbocharger 3 and the combustion cylinders 5.

As shown in FIGS. 3 and 4, the RAS 7 comprises an inlet container 70 for charge air into which the charge air arrives in order to be distributed between the heat exchange surfaces 72 between said charge air and a second heat-transfer fluid. The RAS 7 likewise comprises at the outlet of the heat exchange surfaces 72 an outlet container (not shown) for charge air that collects the cooled air coming from the heat exchange surfaces 72 and guides it toward a conduit, conveying it to the combustion cylinders 5. The second heat-transfer fluid may, for example, be air in the case of an air RAS or glycolated water in the case of a water RAS.

The exchange surfaces 72 may, for example, be flat tubes in which the second heat-transfer fluid circulates and between which the charge air passes.

The RAS 7 may likewise be a plate exchanger. That is to say, the heat exchange surfaces 72 between the charge air and the second heat-transfer fluid may be a stack of communicating exchange plates 74, in which the second heat-transfer fluid circulates between a fluid inlet and a fluid outlet. The charge air then circulates in the space 73 between said exchange plates 74 and can exchange the thermal energy with the second heat-transfer fluid.

The inlet and outlet of the second heat-transfer fluid, for example glycolated water, may be connected to a temperature-regulation circuit, called the low-temperature circuit, such as, for example, the air-conditioning circuit.

The RAS 7 likewise comprises, within its inlet container 70 and/or its outlet container for charge air, a phase change material (MCP) 15. The MCP 15 allows absorption of thermal energy originating from the charge air. This thermal energy absorbed by the MCP 15 is no longer to be dissipated by the RAS 7 when there are temperature peaks. The incorporation of the MCP 15 within the inlet container 70 and/or outlet container for the first heat-transfer fluid thus makes it possible to avoid an increase in the size of the RAS 7.

This is, in particular, shown in FIG. 5, which shows a graph illustrating the evolution of the air temperature at the outlet of an RAS 7 as a function of time and as a function of various types of RASs 7.

The first curve 50 shows the evolution, as a function of time, of the air temperature at the outlet of a conventional prior art RAS 7. It will be noted that there are four particular areas in the temperature curve:
A stable temperature area of t=0 s at t=500 s, where the turbocharger is not in action and where the air temperature at the outlet of the RAS is constant. Under test conditions, this value is of the order of 48°. This temperature value is, of course, likely to vary as a function of exterior temperature conditions and of the temperature of intake air. Thus, under cold climatic conditions, this value may be lower.
An area of a sudden increase in temperature between t=500 s and t=600 s, which corresponds to start-up of the turbocharger 3, which conveys hot, compressed charge air to the RAS.
An area of stabilization of the charge air temperature at a value of the order of 60° C. between t=600 s and t=850 s, which corresponds to the effects of the action of the RAS by dissipation of thermal energy from the charge air. This temperature value is, of course, a function of the efficiency of the RAS used.
An area between t=850 s and t=1000 s, of a return to a stable temperature of the air temperature at the outlet of the RAS identical to that of the first area, owing to the shutdown of the turbocharger 3.

The second curve 52, meanwhile, corresponds to the evolution of the air temperature at the outlet of an RAS 7 of identical size to the preceding RAS and comprising an MCP 15. With just a few differences, the same particular areas are present:
The stabilization area occurs at a lower temperature, of the order of from 54 to 57° C. owing to the action of the MCP 15, which absorbs the thermal energy.
The area of return to a stable temperature of the air temperature after shutdown of the turbocharger 3 is longer and progressive, from t=850 s to t=1400 s, owing to the progressive dissipation of the thermal energy absorbed by the MCP 15.

The third curve 54 corresponds to the evolution of the air temperature at the outlet of an RAS 7 that comprises an MCP 15 but is smaller by around 30% than the preceding RASs. The following will thus be noted:
The stabilization area is identical to that of the RAS without

MCP 15.
The area of return to a stable temperature of the air temperature after shutdown of the turbocharger 3 is likewise progressive, between t=850 s and t=1100 s, owing to the progressive dissipation of the thermal energy absorbed by the MCP 15.

It is thus possible to obtain, with an RAS 7 of smaller size, similar efficiency by virtue of the addition of an MCP 15.

The MCP 15 may, for example, be incorporated into the actual wall of the inlet container and/or the outlet container for charge air.

The MCP 15 may likewise be in the form of capsules of phase change material covered with a protective layer of polymeric material. This type of capsule of MCP 15 is very familiar to a person skilled in the art. The MCP used may, in particular, be an extruded or polymerized MCP of random form such as, for example, of spherical, hemi-spherical or amorphous form, covered with a protective layer of polymeric material. The capsules of MCP 15 preferably have a diameter of between 0.5 mm and 8 mm.

Because of the use temperature ranges in a charge air circuit 1, the MCP 15 used may, in particular, have a phase change temperature of between 180° C. and 200° C. Furthermore, the MCP 15 used may, advantageously, have a latent heat in excess of or equal to 280 kJ/m³ in order to offer optimum efficiency.

If the MCP 15 is in the form of capsules, as illustrated by FIGS. 3 and 4, the inlet container 70 and/or the outlet container for charge air comprising the capsules of MCP 15 comprises means 76 for retaining said capsules of phase charge material 15 within said inlet container 70 and/or said outlet container for charge air.

The retaining means 76 are preferably placed at the inlets and/or outlets of the exchange surfaces 72 in order that the capsules of MCP 15 do not enter between these latter and do not block or impede the charge air stream. The retaining means 76 are likewise placed at the inlet of the inlet container 70 for charge air and/or at the outlet of the outlet container for charge air so that the capsules do not escape into the conduit between the RAS 7 and the turbocharger 3 or toward the combustion cylinders 5.

The retaining means 76 may, for example, be grids having a mesh smaller than the diameter of the capsules of MCP 15 or, alternatively, be filters of the porous diffuser type.

At the inlets and/or outlets of the exchange surfaces 72, the retaining means 76 may, according to a first embodiment shown in FIG. 3, cover the total surface between the inlet container 70 and/or the outlet container for charge air with the exchange surfaces 72.

According to a second embodiment, shown in FIG. 4, the retaining means 76 cover only the spaces 73 in which the charge air circulates.

It can thus readily be seen that the charge air cooler 7 according to the invention allows improved cooling of the charge air owing to the presence of phase change material 15 within. The charge air cooler 7 according to the invention, which is equally as efficient as a conventional charge air cooler, may thus be smaller in size.

1. A charge air cooler intended to be placed upstream from the combustion cylinders, said charge air coming from at least one turbocharger and intended to be supplied to the combustion cylinders of an internal combustion engine, said charge air cooler comprising:
one inlet container for charge air, one outlet container for charge air and heat exchange surfaces between the charge air and a second heat-transfer fluid,
wherein at least the inlet container and/or the outlet container for charge air comprises a phase change material.

2. The charge air cooler as claimed in claim 1, wherein the phase change material is incorporated within the wall of the inlet container and/or the outlet container for charge air.

3. The charge air cooler as claimed in claim 1, wherein the phase change material is in the form of capsules of phase change material placed in the inlet container and/or the outlet container for charge air.

4. The charge air cooler as claimed in claim 3, wherein the inlet container and/or the outlet container for charge air comprising the capsules of phase change material comprises means for retaining said capsules of phase change material within said inlet container and/or said outlet container for charge air.

5. The charge air cooler as claimed in claim 4, wherein the retaining means are placed at the inlets and/or outlets of the exchange surfaces and at the inlet of the inlet container for charge air and/or at the outlet of the outlet container for charge air.

6. The charge air cooler as claimed in claim 4, wherein the means for retaining said capsules of phase change material within the inlet container and/or the outlet container for charge air are grids.

7. The charge air cooler as claimed in claim 4, wherein the means for retaining said capsules of phase change material within the inlet container and/or the outlet container for charge air are filters.

8. The charge air cooler as claimed in claim 1, wherein the phase change material has a phase change temperature of between 180° C. and 200° C.

9. The charge air cooler as claimed in claim 1, wherein the phase change material has a latent heat greater than or equal to 280 kJ/m³.

10. A charge air circuit comprising a charge air cooler as claimed in claim 1.
